(19) United States
(12) Patent Application Publication
(10) Pub. No.: US 2009/0299904 A1
(43) Pub. Date: Dec. 3, 2009

(54) ELECTRONIC COMMERCE SYSTEM AND METHOD ENABLING AUTOMATIC DATA TRANSFER AND AUTHENTICATION METHOD THEREOF

(75) Inventor: Chih-Che Tsai, Hsinchu City (TW)

Correspondence Address: WPAT, PC;INTELLECTUAL PROPERTY ATTORNEYS, 2030 MAIN STREET, SUITE 1300, IRVINE, CA, 92614, US

(73) Assignee: Metison Technologies Corporation, Hsinchu City (TW)

(21) Appl. No.: 12/174,486

(22) Filed: Jul. 16, 2008

(30) Foreign Application Priority Data
May 30, 2008 (TW) 97120302

(51) Int. Cl. G06Q 99/00; H04L 9/28

(52) U.S. Cl. 705/50; 705/10

(57) ABSTRACT

In an electronic commerce system and method, a storage device is utilized to enable automatic and effective web data transfer, so as to solve the problem of low efficiency in recommending and advertising products through using conventional compact disks or browsing web pages, and the web data transferred to a user may be updated through an authentication and comparison mechanism to overcome the problem of unable to update the data on the compact disk sent to the user for sales promotion. And, a web authentication method based on the authentication and comparison mechanism is established to simplify the conventionally complicated login and authentication procedures and effectively solve the problem of data-jacking occurred in web digital data.

### FIELD OF THE INVENTION

The present invention relates to an electronic commerce system and method and authentication method thereof, and more particularly to an electronic commerce system and method utilizing a storage device to enable automatic data transfer and an authentication method thereof.

### BACKGROUND OF THE INVENTION

With the popularization of personal computer and the developments in wideband network, the utility rate of Internet has largely increased. And accordingly leads to the prosperous development of electronic commerce (or called e-commerce). Through the transaction mechanism of e-commerce, consumers are able to conveniently purchase favorite products online. The convenience brought by Internet also makes a huge quantity of web data being easy to obtain. On the other hand, a consumer's browsing over Internet also implies the consumer's purchase inclination. Therefore, it is very important to get the way of collecting consumer-specific product information so as to effectively recommend suitable products to the consumers.

In the past, sellers are used to record information about recommended products or services on compact disks, and send the compact disks to consumers by enclosing the compact disks in some other product packages or being giveaways. However, the information of products or service recorded in the compact disks are not necessarily useful or needed by the consumers. Some consumers would even throw away the compact disks before reading them because it is too troublesome to use. As a result, the sellers do not get any product/service recommending and promoting effect. When it is desired to update the products and service information recorded in the compact disks in a necessary situation, the compact disks used for such purpose must be rewritable or erasable compact disks. Meanwhile, the consumers must have specific compact disk recorder to enable updating of information on the compact disks. Therefore, using compact disks as giveaways only has a low effect in promoting sales.

With the currently available web browsers, such as Internet Explorer (IE) provided by Microsoft®, Firefox Web Browser provided by Mozilla®, Safari provided by Apple® Inc., and web browsers provided by other third parties, the standard Internet Protocol can only allow a web data provider to put web cookies in a user-end computer for tracking the users' web browsing records. Web cookies have been considered as ID tags. However, a user may choose to refuse the writing from the web cookies into the user-end computer, or delete the web cookies at any time. If any of the above two conditions occurs, the information about the user's browsing collected from the user-end computer by the web data provider (i.e. a seller) is useless at all.

Moreover, in the past, any online transaction, such as online shopping, online gaming, etc., requires complicated login and authentication procedures. When it is desired to use a certain web digital data, such as online shopping bonus feedback, online game virtual treasure, etc., these data must be processed at the web server and then easily to be embezzled.

In recent years, due to the advanced semiconductor processing, novel techniques in memory manufacturing have been constantly developed, leading to reduced memory volume and price as well as the popularization of high-capacity storage device, such as USB (universal serial bus) flash drive. For consumers, such readable and writable high-capacity storage devices are more attractive compared to the conventional compact disks.

Therefore, it is tried by the inventor to develop an electronic commerce system and method that utilizes a storage device to achieve product recommendation and sales promotion effect, and adopts relevant web security mechanism to enhance the security of using the system and method, so that consumers are more interested in using the storage device.

### SUMMARY OF THE INVENTION

A primary object of the present invention is to provide an electronic commerce system and method enabling automatic and effective transfer of web data from a web server to a user via a storage device, so as to overcome the problem of low efficiency in recommending and advertising products through using conventional compact disks or browsing web pages.

Another object of the present invention is to provide an electronic commerce system and method enabling automatic and effective transfer of web data from a web server to a user via a storage device, so that the web data to be recommended and transferred to the user and the user's web browsing records are stored in a user read-only area of the storage device without the risk of being deleted or erased.

A further object of the present invention is to provide an electronic commerce system and method enabling automatic and effective transfer of web data from a web server to a user via a storage device, so as to overcome the problem of unable to update the data on the compact disk sent to the user for sales promotion by allowing a web data provider to actively update the web data transferred to a user through data transfer between the storage device and the web server as well as an authentication and comparison mechanism.

To achieve the above and other objects, the electronic commerce system enabling automatic transfer of web data according to the present invention includes a storage device having a program group, a user service serial number, and a flash drive serial number stored thereon, such that when a user connects the storage device to a computer, the program group automatically guides the user to a predetermined web page, and a globally unique identification (GUID) consisting of the user service serial number and flash drive serial number serially connected is automatically sent out; a web server having web data stored thereon for transferring to the user, and being capable of recording all the web data that have been browsed by the user at user login with the GUID; a data management unit being located at the web server for managing various kinds of web data to be transferred to the user; and a recommendation server for analyzing the user's web browsing records to thereby find out the user's preferred web data, associating the user's web browsing records with other users' web browsing records, choosing suitable web data from the web server for transferring to the user.

To achieve the above and other objects, the electronic commerce method enabling automatic transfer of web data according to the present invention includes the steps of storing a program group, a user service serial number, and a flash drive serial number in a storage device, and connecting the storage device to a computer, so that a user of the storage device is automatically guided to a predetermined web page, and a globally unique identification (GUID) consisting of the user service serial number and flash drive serial number serially connected is sent out; recording in a web server the web data that have been browsed at user login with the GUID; and using a recommendation server to analyze the user's web browsing records to find out the user's preferred web data, associate the user's web browsing records with other users' web browsing records, choose suitable web data from the web server for transferring to the user.

A still further object of the present invention is to provide a web authentication method, in which web authentication mechanisms are utilized to simplify the conventionally complicated login and authentication procedures and effectively solve the problem of data-jacking occurred in web digital data.

To achieve the above object, the web authentication method according to the present invention includes the steps of storing a program group, a user service serial number, and a flash drive serial number in a storage device, such that when a user logs in a web server, the storage device automatically transfer a digital data to the web server; the web server verifying a globally unique identification (GUID) consisting of the user service serial number and flash drive serial number serially connected, and verifying the user service serial number and the flash drive serial number; the web server checking the user service serial number along with a serial number of the digital data as an authentication; and the user being allowed to access the digital data in the web server when the user passes the authentication; or, the web server refusing the transferred digital data when the user does not pass the authentication. In addition, an HTTP (Hyper Text Transfer Protocol) request instruction sent by the flash drive is associates with the GUID of the flash drive. Therefore, the uniqueness of the request instruction is ensured. Meanwhile, the request instruction is also encrypted to ensure the security in data transfer.

In an embodiment of the present invention, the storage device is a flash drive having a transmission connector for connecting to a computer, and the transmission connector may be a USB connector or a mini USB connector. The storage device includes a normal read/write area for storing the web data transferred by the recommendation server and allowing a user to access the web data in a normal way; a user read-only area for storing the user's web browsing records and the program group; and a hidden area for storing the user service serial number, the flash drive serial number, and other required data. The hidden area is not readable by an operating system, such as related Microsoft® products. And, all the data input and output procedures of the hidden area and the recommending sever are under security control through the AES (Advanced Encryption Standard) and the RSA encryption systems.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps for an electronic commerce method in automatic web data transferring according to the present invention; and

FIG. 2 is a flowchart showing the steps for a web authentication method in automatic web data transferring according to the present invention.

### DETAILED DESCRIPTION OF THE PREFERRED EMBODIMENTS

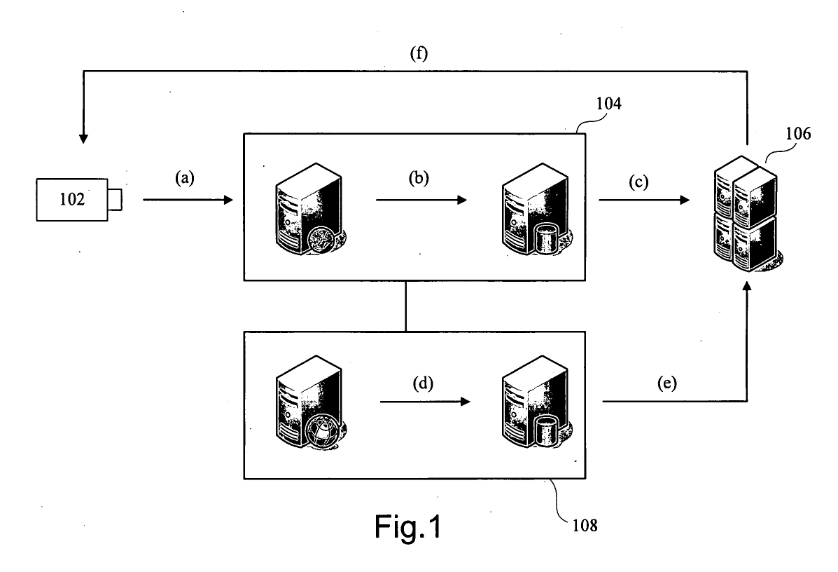

Please refer to FIG. 1. The present invention directs to a mechanism that utilizes a storage device to enable the web data transfer sent to a user automatically. In the illustrated embodiment of the present invention, the storage device is a flash drive, which has a transmission connector for connecting to a computer. The transmission connector may be a USB connector or a mini USB connector. The flash drive includes three storage areas having different attributes, namely, a normal read/write area, a user read-only area, and a hidden area.

The normal read/write area is used to store web data that are recommended and transferred to the user from a recommendation server, and likewise the user may perform general data access in this area.

The user read-only area is used to store records about the user's browsing over Internet and a program group. The program group includes at least five files as follows:
1. iMarketr.exe: This file is used to receive the newest data transferred to the user from the recommendation server. When the flash drive is linked with Internet, the data is accessed from the recommendation server. Or, when the flash drive is not linked with Internet, the data is accessed from the normal read/write area in the flash drive as will be described in more details later. In the latter case, the user's browsing records at offline would be stored in the user read-only area and transmitted to a web server when the flash drive is linked with Internet next time.
2. iMUpdatr.exe: This file is used to check for any required file to be updated when the flash drive is connected to the web server through Internet.
3. Autorun.inf: This file enables virtualization of the flash drive into a compact disk device, and has a configuration file for auto running, so that the flash drive may automatically run relevant settings when being connected to a computer.
4. iMarketr.hex: This is a default backup file. When a default data in the normal read/write area of the flash drive is erased or in error, the erased or error default data may be recovered by using this file.
5. iMarketr.ico: This is an icon file for the program iMarketr.exe.

The hidden area is used to store a user service serial number, a flash drive serial number, and other data, such as a bank password. The flash drive serial number is a unique serial number that is different from any other serial numbers for other flash drives. The user service serial number is used to limit a specific data, which is used only by a flash drive satisfying the specific service serial number. Thus, different flash drives might have the same user service serial number when the same web data provider (i.e. the seller) purchases the same service. However, these flash drives still have a unique serial number each. On the other hand, the same web data provider or seller might purchase different services, so that the flash drives purchased by the web data provider or seller for promoting as giveaways might have different user service serial numbers. Briefly speaking, the user service serial number limits the programs that are available for the user and the web data provider or seller. The user service serial number followed by the flash drive forms a globally unique identification (GUID), which may be used in tracking and managing services.

The flash drive cooperates with the web server, a data management unit, and the recommendation server to provide the function of automatically transferring web data to a particular group of users or an individual user. The mechanism for such automatic data transfer will be described in more details later.

FIG. 1 is a flowchart showing the steps for an electronic commerce method in automatic data transferring according to the present invention. The steps include:
(a) A user makes a flash drive 102 connecting to a computer. By a program group stored on a user read-only area in the flash drive 102, the program group would run automatically to guide the user to a web page, and sends out a GUID consisting of the user service serial number and the flash drive serial number of the flash drive 102. Via the program group, the GUID is encrypted through AES (Advanced Encryption Standard) and RSA encryption systems. The encrypted GUID is then transmitted via Internet to a web server 104, at where the encrypted serial numbers are decrypted. The web server 104 would record all the GUIDs of logging in and still online. Therefore, if a GUID has been recorded in the web server 104, it would be considered as a malicious web user and be blockaded by the web server 104 when still another user with the same GUID try to login. On the other hand, if an entered GUID is not found in the web server 104, the web server 104 would allow the user to login with the GUID. Thereafter, the web server 104 would authenticate the user service serial number and the flash drive serial number to identify the user, and records a message about the user having logged in.
(b) The web server 104 records the progress of the user's web data browsing over Internet, and to form it as a browsing record.
(c) A recommendation server 106 uses a known collaborative filtering or other filtering process to analyze the user's and other users' browsing records stored on the web server 104, so as to know the user's preference from the most frequently browsed web data. Based on the analysis, the recommendation server 106 chooses the most suitable web data from all the web data provided by a web data provider and stored on the web server 104 to use as a recommended web data to the user, and automatically transfers the recommended web data to the user through Internet. The recommended web data would be stored on a normal read/write area in the flash drive 102 and displayed on the user's computer screen. When the user makes the flash drive 102 connecting to the computer next time while the flash drive 102 is not linked with Internet, the user can access the recommended web data from the normal read/write area. In this manner, no matter whether the user is linked with Internet or not, the web data provider can always achieve the purpose of recommending web data to the user. Moreover, in the process of the web data transmitting, all the output procedures of the web server 104 and all the input procedures of the flash drive 102 are subjected to security control via the AES and RSA encryption systems, so that all the web data are encrypted. Further, the web data provider or seller may automatically provide updated or new recommended web data to the user via a data management unit 108 located at the web server 104. Of course, the functions of providing updated or new web data depend on the services purchased by the seller. That is, the services purchased by the seller would form limitation to the functions of the program group and the authority to the seller for operating via the data management unit 108.
(d) The data management unit 108 is located at the web server 104. The web data provider or seller may link with the data management unit 108 over Internet via any of the currently available web browsers, such as Internet Explorer (IE) provided by Microsoft®, Firefox provided by Mozilla®, Safari provided by Apple®, and many other browsers provided by other third parties, so as to provide updated or new recommended web data to the user, and the web data is stored on the web server 104. Moreover, in addition to the management of web data, the data management unit 108 may also adjust the program group in the user read-only area of the flash drive 102 via Internet, so as to actively achieve the object of program version upgrade. However, the program version upgrade can be performed only by a manager of the web server 104. Since updating of the program group is a point-to-point writing method, before the program group enables the update procedure, the data management unit 108 would first compare the original user service serial number and the original flash drive serial number stored on the web server 104 with the user service serial number and the flash drive serial number stored in the hidden area of the flash drive 102. The updating starts only when a comparison result indicates the serial numbers are matched respectively. Therefore, in the event the program group stored in the user read-only area is moved out of the flash drive 102, an error shown in the serial number comparison result caused at least by mismatched flash drive serial number would interrupt the normal updating. Thus, the program group is much better protected compared to those programs that can be sent simply through copy.
(e) Through integration in a databank of the web server 104, the web data provided by the web data provider or seller may be transferred via the recommendation server 106 to the user as the recommended web data.
(f) Through the recommendation by the recommendation server 106, web data suitable for the user to read are transferred to the web pages browsed by the user and also directly transferred to the flash drive 102, so that the user may browse the web data offline. The progress of browsing offline may also be recorded in the user read-only area in the flash drive 102, and the progress record is transmitted to the web server 104 for processing when the flash drive 102 is linked with Internet next time.

Therefore, unlike the conventional compact disks, the present invention stores the web data provided to user by the web data provider or seller in the normal read/write area in the flash drive 102 for the user to read. That is, when the flash drive 102 is connected to the computer, the programs in the user read-only area are mounted to automatically guide the user to the predetermined web pages, forcing the user to accept and read the web data provided to the user by the web data provider or seller each time the user uses the flash drive 102. In addition, the web data provider or seller may modify the data in the user read-only area via the data management unit 108. That is, while the user read-only area is read-only to the user, it is amendable and upgradeable to the web data provider or seller. Therefore, the web data provider or seller needs only to provide the user a flash drive 102, and any future updated or new web data can be provided to the user simply by amendment via the data management unit 108. With these arrangements, the present invention is completely different from the conventional ways of sending new compact disk to the user or putting the updated or new data over Internet for user to download.

The present invention also enables multicast in group or single of data transferring. The web data provider or seller may set that the data in the web page is readable only by some users of a flash drive 102 having a specific serial number. That is, when transferring the web data, the recommendation server 106 would utilize the authentication of the serial numbers to automatically check whether the web data is readable by a group of users or an individual user. If the authentication is passed, it means the web data is allowed for reading; and if not, the web data is not accessible. In this manner, the data may be transferred to a specific group of users or a specific individual user.

Regarding the statistic of data browsing, since every flash drive 102 is assigned a set of special serial numbers, that is, the GUID, every browsing record can be clearly corresponded to one flash drive user who browses the web data. The utilization of the flash drive to achieve the function of transferring web data enables clear statistic about what data having been read by which users. Therefore, the web data provider or seller could get more accurate statistical data indicating the users' preferences. The present invention may be, therefore, applied in the subscription of electronic books, paid transfer of security exchange information, general commercial advertisement, etc.

In the case of subscription of electronic books, when an electronic book subscriber owns one flash drive given by an electronic book publisher, and the subscriber connects the flash drive to a computer, the flash drive would automatically download the subscribed electronic book from the web server. The electronic book content is stored in the normal read/write area of the flash drive. The file containing the electronic book can always be accessed from the normal read/write area when the flash drive is carried to different places for reading. Each time a reader searches for electronic books, the search behavior is recorded as the reader's preference for reading, and the record is stored on the web server and in the user read-only area of the flash drive. With the help of a recommendation server, the reader is able to collect the desired electronic book within a shortened time.

In the case of paid transfer of stock exchange information, due to the popularization of online stock transaction, most investors would acquire investment news and related information over Internet. In the past, the paid transaction data are acquired through short message on mobile phone or other receiving and transmitting devices. Now, the paid transaction data can be transferred to a paid member simply via the multicast service provided by the flash drive. The paid member needs only to connect the flash drive to a computer, and the data provided by the analyst would be automatically transferred from the recommendation server to the paid member. The recommendation server would determine and transfer the most suitable data to the paid member according to the member's asset condition, the types and amount of stocks held by the member, and past records showing the member's browsing, so that the member could acquire stock market information more effective.

In the case of general commercial advertisement, the seller may purchase the flash drive as a giveaway. When the user plugs the obtained flash drive in a computer, the web server would automatically transfer the seller's intended advertisement to the user. When the user clicks on the advertisement, the recommendation server would learn the user's preference from the user's behavior of clicking and further choose and recommend the suitable advertisement for the user to thereby increase the user's desire of buying. In addition to the transfer of advertisement, the seller may also provide the user with discount coupons to increase the user's desire of buying. The seller may also try to get the user's attitude toward the seller's products through an online questionnaire, so that the seller may make proper and necessary modification to the products. The seller's advertisement would always have chances to be read by the user as long as the user would use the flash drive given by the seller. Compared to the conventional way of putting the advertising materials on the seller's website for viewing by all people, the sending of the advertising materials to the user via the flash drive according to the present invention is active and more effective.

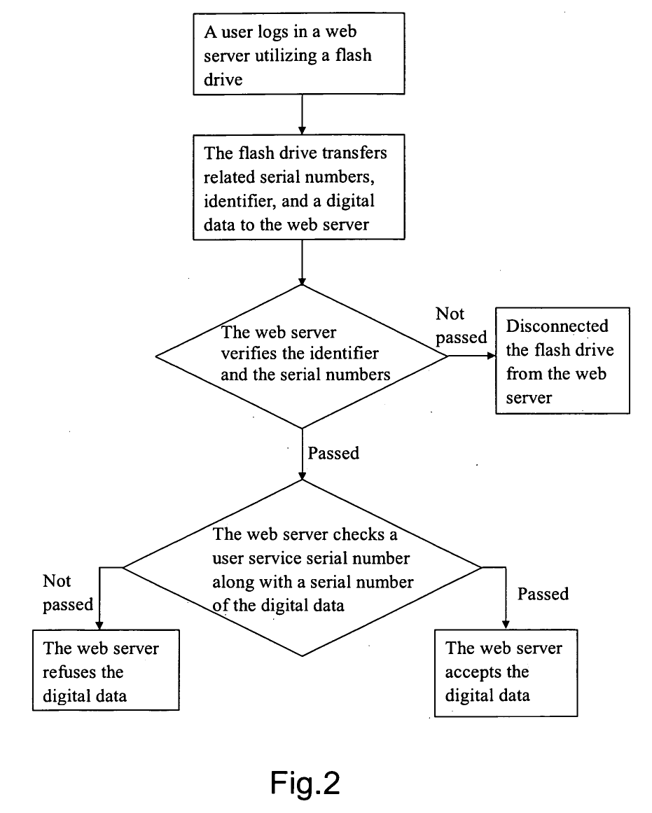

Further, the transmission mechanism according to the present invention may also be used as a way of web authentication. Please refer to FIG. 2, which is a flowchart showing the steps included in a method of web authentication in automatic data transferring by an electronic commercial system. In the first step, a needed digital data, a program group, a flash drive serial number, and a user service serial number are stored in a flash drive 102. When a user logs in the web server 104 using the flash drive 102, the flash drive 102 automatically transmits the needed digital data and a GUID consisting of the user service serial number and the flash drive serial number to the web server 104. Wherein, via the program group, the needed digital data and the GUID are encrypted through the AES and RSA encryption systems.

The web server 104 will decrypt the digital data and the GUID, and checks the GUID first. In the event some other user logs in the web server 104 with a GUID that is already existed in the web server 104, that user would be considered as a malicious user and the web server 104 would immediately blockade the user. On the other hand, when a GUID entered by a user is not found in the web server 104, the web server 104 will allow the user to login with the GUID. Then, the web server 104 would proceed with the authentication of the user service serial number and the flash drive serial number. The authentication of a serial number of the digital data would be proceeded with only when the above two serial numbers have passed the authentication of the web server 104. The serial number of the digital data will be checked along with the flash drive serial number in the authentication thereof. The user is allowed to use the digital data over the web server 104 only when the serial number of the digital data has passed the authentication. On the contrary, when the serial number of the digital data does not pass the authentication, the web server 104 would refuse the transfer and use of the digital data. Moreover, the authentication process is continuously and repeatedly performed. Therefore, once the user disconnects the flash drive 102 from the computer, the user is no longer allowed to use the digital data in the web server 104.

According to the present invention, all the related serial numbers are stored in the hidden area in the flash drive. Since the hidden area is not accessible even by the Operating System, the data is not subject to the risk of data-jacking. Therefore, it is possible for some web servers requiring authentication to omit the procedure for a user to input the serial numbers and passwords, and these serial numbers in the hidden area of the flash drive may be checked directly by the web server 104. When all the serial numbers are verified as correct, the user is allowed to access the digital data over the web server 104. The digital data may be, for example, online shopping bonus feedback, online game virtual treasure, etc.

For example, in the management of the online game virtual treasure, due to the appearance of Trojan Horse, many electronic game dealers have encountered the problem that virtual treasures of many game players' in the online game are stolen. In the event a flash drive is used as a medium for transferring online game virtual treasure, the game player must first plug the flash drive in the computer to enable running of the game software. Without the connection between the flash drive and the computer, the user could not continue the use of the online game virtual treasure and would be kicked out of the web game server. The authentication of the online game virtual treasure requires those serial numbers stored in the flash drive. The virtual treasure can be considered as executable and legal only when the serial numbers have passed the authentication. In addition, the progress of the player in the online game can also be recorded in the user read-only area in the flash drive. When the player runs the game software on a different computer, the recorded progress stored in the flash drive is automatically read to omit the step of identity authentication that is usually required when logging in another computer. Therefore, the online game virtual treasure is no longer a set of data stored on the web server, but are stored in the user's flash drive. Since the serial number of the online game virtual treasure is authenticated along with other serial numbers stored in the flash drive, any other online game virtual treasure stolen from another player and stored in a different flash drive would be considered as illegal when the online game is proceeded.

In brief, the present invention utilizes a storage device to solve the problem of low efficiency in recommending and advertising products through using conventional compact disks or browsing web pages. A user's browsing progress can be completely stored in the storage device without the risk of being deleted or erased. Through any web browser, a web data provider or seller may achieve the purpose to actively transfer recommended data and sales promotion materials via the data management unit at the web server and the program group stored in the storage device. The web data provider or seller may also transfer the recommended web data by the way of multicast in group or single. Moreover, the present invention uses the GUID authentication system to prevent invasion and data diddling by hackers, so that the data can be transferred over Internet in a faster, safer, and more effective manner. Further, in the present invention, the use of the flash drive by the seller as a giveaway is more attractive to users, compared to the compact disks used in the conventional way of sales advertising and promoting. In other words, the flash drive is widely accepted by users and can therefore assist the seller in achieving highly satisfactory advertising effect.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An electronic commerce system enabling automatic data transfer, comprising:
a storage device having a program group, a user service serial number, and a flash drive serial number stored thereon, such that when a user connects the storage device to a computer, the program group automatically guides the user to a predetermined web page, and a globally unique identification (GUID) consisting of the user service serial number and flash drive serial number serially connected is automatically sent out;
a web server having web data stored thereon for transferring to the user, and being capable of recording all the web data that have been browsed by the user when the user logs in the web server with the GUID;
a data management unit being located at the web server for managing various kinds of web data to be transferred to the user; and
a recommendation server for analyzing the user's web browsing records to thereby find out the user's preferred web data, associating the user's web browsing records with other users' web browsing records, choosing suitable web data from the web server for transferring to the user.

2. The electronic commerce system as claimed in claim 1, wherein the storage device is a flash drive; the flash drive having a transmission connector for connecting to the computer, and the transmission connector being a USB connector or a mini USB connector.

3. The electronic commerce system as claimed in claim 1, wherein the storage device includes:
a normal read/write area for storing the web data transferred by the recommendation server;
a user read-only area for storing the user's web browsing records and the program group; and
a hidden area for storing the user service serial number and the flash drive serial number.

4. The electronic commerce system as claimed in claim 3, wherein the user read-only area allows the data management unit to write in data, so as to update the program group and/or the web data transferred by the recommendation server.

5. The electronic commerce system as claimed in claim 4, wherein, in updating the program group or updating the web data transferred by the recommendation server, the data management unit first compares the original user service serial number and the original flash drive serial number stored in the web server with those stored in the storage device, and then starts updating when the comparison result shows the serial numbers are matched each other.

6. The electronic commerce system as claimed in claim 1, wherein the various kinds of web data for transferring to the user are provided by a web data provider, and the web data provider is able to manage the web data via the data management unit.

7. The electronic commerce system as claimed in claim 1, wherein the data stored in the storage device may be updated by a web data provider via the data management unit and the program group.

8. The electronic commerce system as claimed in claim 1, wherein AES and RSA encryption systems are adopted for security control in transmitting the web data, including all output procedures of the web server and all input procedures of the storage device.

9. An electronic commerce method enabling automatic data transfer, comprising the steps of:
storing a program group, a user service serial number, and a flash drive serial number in a storage device, and connecting the storage device to a computer, so that a user of the storage device is automatically guided to a predetermined web page, and a globally unique identification (GUID) consisting of the user service serial number and flash drive serial number serially connected is sent out;
recording in a web server the web data that have been browsed by the user at user login with the GUID, the user service serial number, and the flash drive serial number; and
using a recommendation server to analyze the user's web browsing records to find out the user's preferred web data, associate the user's web browsing records with other users' web browsing records, choose suitable web data from the web server for transferring to the user.

10. The electronic commerce method as claimed in claim 9, further comprising the steps of:
storing the transferred web data in a normal read/write area of the storage device;
storing the program group in a user read-only area of the storage device; and
storing the user service serial number and the flash drive serial number in a hidden area of the storage device.

11. The electronic commerce method as claimed in claim 10, further comprising the steps of:
the user browsing the web data stored in the normal read/write area of the storage device when the user is not linked with Internet, and
the storage device storing the user's browsing record in the user read-only area, so that the user's browsing record is uploaded to the web server when the user is linked with Internet next time.

12. The electronic commerce method as claimed in claim 9, wherein the program group can be updated via a data management unit located at the web server.

13. The electronic commerce method as claimed in claim 12, wherein, in updating the program group, the data management unit first compares the original user service serial number and the original flash drive serial number stored in the web server with the user service serial number and the flash drive serial number stored in a hidden area of the storage device, and the updating starts only when a comparison result shows the serial numbers are matched each other.

14. The electronic commerce method as claimed in claim 12, wherein the various kinds of web data for transferring to the user are provided by a web data provider, and the web data provider is allowed to manage the web data via the data management unit.

15. The electronic commerce method as claimed in claim 12, wherein the data stored in the storage device may be updated by a web data provider via the data management unit and the program group.

16. The electronic commerce method as claimed in claim 9, wherein AES and RSA encryption systems are adopted for security control in transmitting the web data, including all output procedures of the web server and all input procedures of the storage device.

17. A web authentication method, comprising the steps of:
storing a program group, a user service serial number, and a flash drive serial number in a storage device, such that when a user logs in a web server, the storage device automatically transfers a digital data to the web server;
the web server verifying a globally unique identification (GUID) consisting of the user service serial number and the flash drive serial number serially connected, and verifying the user service serial number and the flash drive serial number;
the web server checking the user service serial number along with a serial number of the digital data as an authentication; and
the user being allowed to access the digital data in the web server when the user passes the authentication; or, the web server refusing the transferred digital data when the user does not pass the authentication.

18. The web authentication method as claimed in claim 17, further comprising the following step:
storing the user's records of using the digital data over the web server in the storage device.

19. The web authentication method as claimed in claim 18, wherein the storage device includes:
a normal read/write area for storing the digital data;
a user read-only area for storing the user's records of using the digital data over the web server and the program group; and
a hidden area for storing the user service serial number and the flash drive serial number.

20. The web authentication method as claimed in claim 17, wherein the storage device is a flash drive; the flash drive having a transmission connector for connecting to a computer, and the transmission connector being a USB connector or a mini USB connector.
